(19) United States
(12) Patent Application Publication
(10) Pub. No.: US 2005/0113548 A1
(43) Pub. Date: May 26, 2005

(54) Solid powder coating crosslinker

(76) Inventors: Richard R. Roesler, Wexford, PA (US); James W. Rawlins, Leverkusen (DE); Eric J. Vidra, Pittsburgh, PA (US); Dinesh Pethiyagoda, Pittsburgh, PA (US)

Correspondence Address: BAYER MATERIAL SCIENCE LLC, 100 BAYER ROAD, PITTSBURGH, PA, 15205, US

(21) Appl. No.: 10/723,646

(22) Filed: Nov. 26, 2003

(51) Int. Cl. C08G 18/00

(52) U.S. Cl. 528/44

(57) ABSTRACT

The present invention is directed to a crystalline, fully blocked polyisocyanate prepared by reacting NTI with a blocking agent.

### BACKGROUND OF THE INVENTION

Powder coatings constitute an increasing proportion of the coatings industry. The market potential for polyurethane-based powder coatings has been limited due to the crosslinkers used. One of the limitations with polyurethane-based powder coatings is the relatively high equivalent weight of the crosslinker currently used. Because of the higher equivalent weight of the crosslinker, a larger amount is needed, which increases the overall cost of the coating. A need, therefore, exists for a low equivalent weight polyurethane powder crosslinker.

Nonane triisocyanate (NTI or 4-isocyanatomethyl-1,8-octane diisocyanate) is a known material. Various uses for NTI have been suggested. See, e.g., U.S. Pat. Nos. 4,314,048; 5,714,564; 5,854,301; 6,084,051; 6,090,939; 6,100,326; 6,291,578; 6,399,691; 6,432,485; 6,433,072; 6,531,535; 6,566,444; and 6,605,669.

### DESCRIPTION OF THE INVENTION

We have discovered that the fully blocked reaction product of NTI with a blocking agent is a crystalline material that can be used in powder coatings as a crosslinker. The reaction product has a sharp melting point (in the case of dimethylpyrazole, 83° C.). The reaction product has the lowest equivalent weight of any of the commercially available blocked polyisocyanates.

More particularly, the present invention is directed to a crystalline, blocked isocyanate prepared by reacting of NTI with a blocking agent. Preferred are the pyrazole blocking agents and the preferred pyrazole blocking agents are selected from the group consisting of 3,5-dimethylpyrazole, 4-nitro-3,5-dimethylpyrazole, 4-benzyl-3,5-dimethylpyrazole, methyl-5-methylpyrazole-3-carboxylate, pyrazole, 3-methyl-5-phenylpyrazole, 3-methylpyrazole, 4-bromo-3,5-dimethylpyrazole and 3,5-dimethylpyrazole-4-carboxanilide, with 3,5-dimethylpyrazole being most preferred. Other blocking agents can also be used. Examples include secondary or tertiary alcohols (such as, isopropanol or tert-butanol); acidic methylene compounds (such as, malonic acid dialkyl esters, acetyl acetone or acetoaceticacid alkyl esters); oximes (such as, formaldoxime, acetaloxime, methyl ethyl ketoxime, cyclohexanone oxime, acetophenone oxime, benzophenone oxime, or diethylglyoxime and the oxime-type blocking agents described in U.S. Pat. No. 6,291,578); lactams (such as ε-caprolactam or δ-valerolactam); phenols (such as, phenol, cresol or nonyl phenol); N-alkylamides (such as, N-methyl acetaminde); imides (such as, phthalimide); and imidazole. A sufficient amount of the blocking agent is used to react with all the isocyanate groups of the NTI.

As used herein, “NTI” is intended to mean nonane triisocyanate. As is clear from the art, in addition to being called nonane triisocyanate (U.S. Pat. No. 6,084,051), nonane triisocyanate has been called i) 4-isocyanate methyl-1,8-octamethylene diisocyanate (U.S. Pat. No. 4,314,048), ii) 4-isocyantomethyl-1,8-octamethylene diisocyanate, (U.S. Pat. No. 5,714,564), iii) 4-isocyanatomethyl-1,8-octane diisocyanate (U.S. Pat. No. 6,090,939), iv) triisocyanatononane and TIN (U.S. Pat. No. 6,090,939), and v) 4-isocyanatomethyloctane-1,8-diisocyanate (U.S. Pat. No. 6,100,326).

The preferred pyrazole blocking agents are known in the art and have been described in U.S. Pat. Nos. 4,976,837, 5,246,557, 5,521,272 and 5,986,033, all the disclosures of which are hereby incorporated by reference.

Reaction times will depend on the reaction temperatures, but are typically between one and eight hours. Reaction temperatures can be from 50° C. to 120° C., with temperatures of between 60° and 80° C. being preferred to give reasonable reaction times with low color. The temperature has to be high enough to be above the melting point of the resin and to give a reasonable viscosity for stirring. No solvent is used in these materials.

The invention is further illustrated by the following examples in which all parts and percentages are by weight unless otherwise indicated.

### EXAMPLES

In the example, the NTI used was a commercially available NTI having an isocyanate equivalent weight as determined by NCO end group titration of 87 (in theory, the pure NTI would have an equivalent weight of 84).

Preparation of Crosslinker

Into a one liter flask fitted with agitator, nitrogen inlet, thermocouple and heater were charged 203.9 parts (2.36 equivalents) of triisocyanatononane and 77 parts of acetone. Stirring was done until the solution was homogenous. The flask was at 20° C. At this time, 231.7 parts (2.41 equivalents) of powdered 3,5-dimethylpyrazole was added at such a rate to maintain the temperature below 65° C. A strong exotherm required the use of a water/ice bath to maintain the temperature at 65° C. The reaction was cooled and held at 55° C. for an additional three hours. The NCO content by FT-IR was zero. Upon cooling, the product crystallized from solution. The material was dried. The melting point by DSC was 83° C.

Gel Time with Polyester Polyol

Gel times are used to determine the reactivity and utility of a powder coatings crosslinker. Gel times too fast prevent flow and give, for example, poor gloss. Gel times too slow would give too long a cure time for commercial utility. The material of this invention gives gel times that are ideal or intermediate for lower curing polyurethane powder coatings. The standard gel test temperature is 200° C. The low gel times with good flowout was a surprise.

Into a small blender cup was weighed 0.878 parts (0.0048 equivalents) of the crosslinker prepared above and 9.122 parts (0.0049 equivalents) of Rucote GXB 1005 a commercially available polyester polyol from Bayer Polymers LLC. [Rucote GXB 1005 is a terephthalate polyester having an OH number of 30, an acid value of about 4, a viscosity at 200° C. of 5000 cps and a T_{g} of about 60° C.] The material was ground in a blender for 30 seconds The gel times are given in the following table:

| Temperature | Gel Time |
|---|---|
| 120° C. | 77 sec |
| 150° C. | 51 sec |

Gel time reactivity is a test method using a Coesfeld Geltest GT16 gel time meter that determines the reactivity of the coating. Gel time is the time required to pass the coating material from a solid through liquid state to a gelled state at a defined temperature. The sample is measured out using a 114 teaspoon (approximately 0.9 grams). As the sample is placed onto the hotplate, a timer is started. The sample is stirred in a circular motion using the tip of a wooden applicator stick. As the material begins to gel, a strand can be pulled from this material by raising the applicator tip. When a stand is pulled and it breaks easily, the timer is stopped and this is the gel time reactivity of this material.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A crystalline, fully blocked polyisocyanate prepared by reacting NTI with a sufficient amount of a blocking agent to react with all the isocyanate groups of the NTI.

2. The blocked polyisocyanate of claim 1 wherein said blocking agent is selected from the group consisting of pyrazole blocking agents, secondary or tertiary alcohols, acidic methylene compounds, oximes, lactams, phenols, N-alkylamides, imides, and imidazole.

3. The blocked polyisocyanate of claim 1, wherein said blocking agent is a pyrazole blocking agent.

4. The blocked polyisocyanate of claim 3, wherein said blocking agent is selected from the group consisting of 3,5-dimethylpyrazole, 4-nitro-3,5-dimethylpyrazole, 4-benzyl-3,5-dimethylpyrazole, methyl-5-methylpyrazole-3-carboxylate, pyrazole, 3-methyl-5-phenylpyrazole, 3-methylpyrazole, 4-bromo-3,5-dimethylpyrazole and 3,5-dimethylpyrazole-4-carboxanilide,

5. The blocked polyisocyanate of claim 3, wherein said blocking agent is 3,5-dimethylpyrazole.
